(19) United States
(12) Patent Application Publication
(10) Pub. No.: US 2014/0087666 A1
(43) Pub. Date: Mar. 27, 2014

(54) BLUETOOTH EARPHONE

(71) Applicant: DEXIN CORPORATION, New Taipei City (TW)

(72) Inventor: YI-SHUN CHEN, New Taipei City (TW)

(73) Assignee: Dexin Corporation, New Taipei City (TW)

(21) Appl. No.: 13/671,792

(22) Filed: Nov. 8, 2012

(30) Foreign Application Priority Data
Sep. 26, 2012 (TW) 101218613

(51) Int. Cl. H04R 1/10

(52) U.S. Cl. CPC H04R 1/1016
USPC 455/41.3

(57) ABSTRACT

A Bluetooth earphone comprises a main module, an ear hanger, a flexible connection unit, and an earpiece speaker. The main module is used for transmitting and receiving Bluetooth signals. The ear hanger is formed by a curved extension of the main module. The earpiece speaker is connected to the ear hanger by the flexible connection unit.

### BACKGROUND OF THE INVENTION

1. Field of the Invention

The instant disclosure relates to a Bluetooth earphone; in particular, to a Bluetooth earphone with an earpiece speaker suspended from a main module.

2. Description of Related Art

Consumer electronic products on the current market such as smart phones, laptops, and desktops by and large have the ability to transmit and receive Bluetooth signals, thereby allowing users to make phone calls or listen to music through wireless earphones.

A common Bluetooth earphone, as shown in FIG. 1, includes a main module 10′, a first earpiece speaker 20′, and a second earpiece speaker 30′. The second earpiece speaker 30′ is connected to the main module 10′ by an audio cable 40′. However, the first earpiece speaker 20′ and the main module 10′ are fixedly attached to each other. Therefore, the angle of a user's ear canal affects the resting position of the main module 10′ when the first earpiece speaker 20′ is inserted inside the user's ear canal. Consequently, the configuration cannot be adapted to varying angles of ear canals of different users, resulting in poor conformation. Moreover, due to the fixed attachment between the first earpiece speaker 20′ and the main module 10′, the first earpiece speaker 20′ and the main module 10′ are likely to produce resonance and feedback when the user listens to stereo on high volume, resulting in a difference between the first speaker 20′ and the second speaker 30′ for the listener, thereby compromising the stereo quality.

Therefore, coming up with a structural design that improves the above mentioned problems of conformation and feedback has become an important task for people in the business. Hence, the inventor of the present application believes that the above mentioned problems can be improved and through devoted research combined with applicable theories, has proposed the instant disclosure which effectively improves the above mentioned problems by implementing a practical design.

### SUMMARY OF THE INVENTION

The objective of the instant disclosure is to provide a Bluetooth earphone that suspends the earpiece speaker on the main module, thereby effectively improving the conformation of the Bluetooth earphone and eliminating feedback between the speaker and the main module.

In order to achieve the aforementioned objective, the instant disclosure provides a Bluetooth earphone which includes: a main module for transmitting and receiving Bluetooth signals; an ear hanger formed by a curved extension of one end of the main module; an earpiece speaker connected to the ear hanger by a flexible connection unit. The Bluetooth earphone can further include an auxiliary earpiece speaker, connected to a connection port of the main module by an additional flexible connection unit.

In summary of the above, the instant disclosure provides a Bluetooth earphone, which can effectively improve the conformation and eliminate feedback between the earpiece speaker and the main module by a design wherein the earpiece speaker is connected to the ear hanger by a flexible connection unit.

In order to further the understanding regarding the instant disclosure, the following embodiments are provided along with illustrations to facilitate the disclosure of the present invention. However the illustrations provided are simplistic schematic diagrams meant for reference only, and are not meant to define the instant disclosure in a limiting fashion.

### BRIEF DESCRIPTION OF THE DRAWINGS

FIG. 1 shows a schematic diagram of a common Bluetooth earphone;

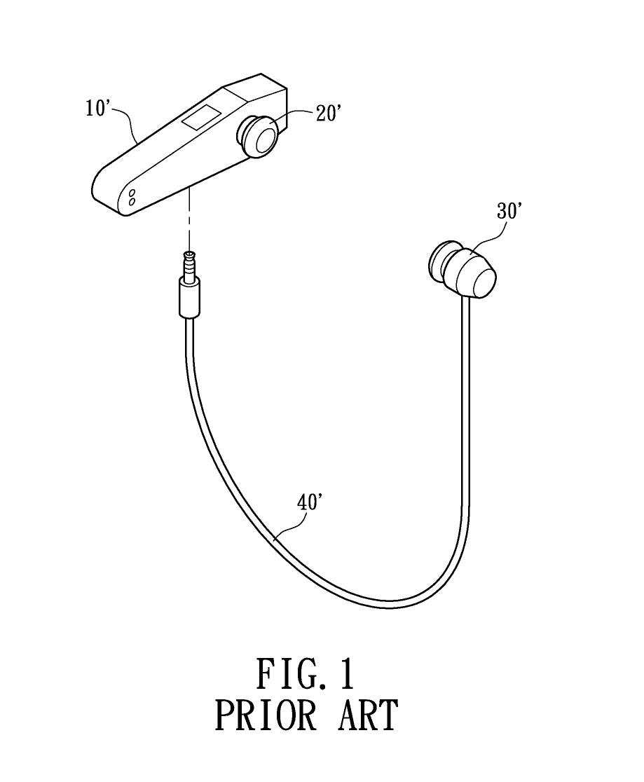

FIG. 2 shows a perspective schematic diagram of a Bluetooth earphone of the instant disclosure according to a first embodiment of the present invention;

FIG. 3 shows a schematic diagram of a Bluetooth earphone of the instant disclosure hooked onto the ear of an user;

FIG. 4 shows a partial exploded perspective schematic diagram of a Bluetooth earphone according to a second embodiment of the instant disclosure;

FIG. 5 shows an assembled perspective schematic diagram of a Bluetooth earphone according to a second embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the present invention will be illustrated in the subsequent descriptions and appended drawings.

### First Embodiment

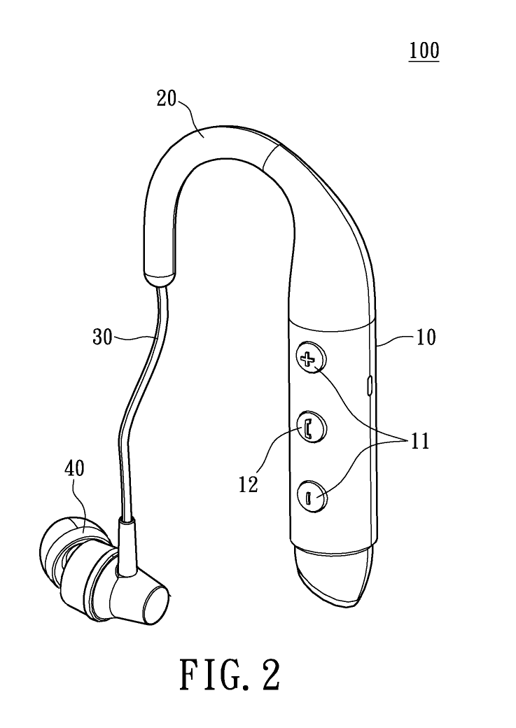

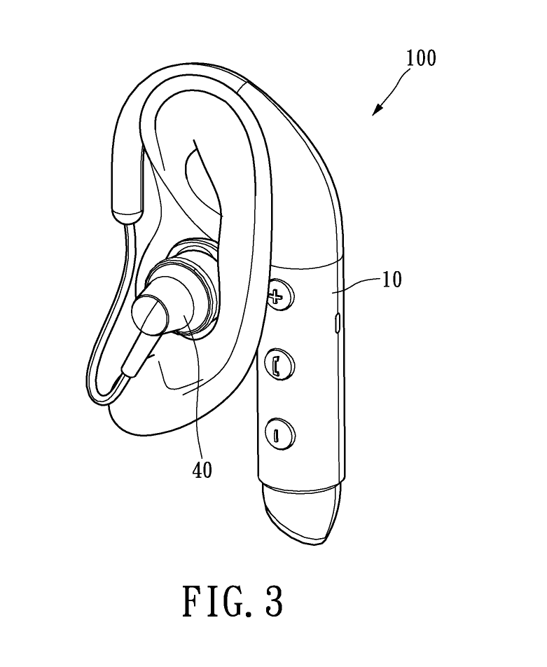

Referring to FIG. 2 and FIG. 3, the instant disclosure provides a Bluetooth earphone 100 compatible with electronic products having Bluetooth transmission and reception equipment such as laptops, desktops, and smart phones. The Bluetooth earphone 100 of the instant disclosure includes a main module 10, an ear hanger 20, a flexible connection unit (namely the first flexible connection unit 30), and an earpiece speaker (namely the first earpiece speaker 40).

The main module 10 is used to transmit and receive Bluetooth signals. The ear hanger 20 is formed by a curved extension of the main module 10. The first earpiece 40 is connected to the ear hanger 20 by the first flexible connection unit 30. In detail, the main module 10 is equipped with two control keys 11 and one function key 12. The control keys 11 can be used to adjust the volume of the first earpiece speaker 40. The function key 12 can be used to activate or deactivate Bluetooth signal transmission and reception. The curved extension of the ear hanger 20 and the main module 10 approximately form an inverted J. The concave part of the J-shaped ear hanger 20 can hook onto a user's ear. The end further away from the main module 10 on the ear hanger 20 is connected to the first flexible connection unit 30, which is ideally an audio cable. The first earpiece speaker 40 is suspended on the ear hanger 20 by said audio cable. The above mentioned first flexible connection unit 30 can be a cable made of rubber, but its material is not limited therein and can be made of other flexible material. Additionally, the above mentioned first earpiece speaker 40 is ideally an insertion type earphone.

With this mechanism, as shown in FIG. 3, when the Bluetooth earphone 100 is hooked onto a user's ear and the first earpiece speaker 40 inserted into the user's ear canal, the first earpiece speaker 40 is not subject to restrictions from the main module 10 and the angle of the user's ear canal, and therefore can conform to different angles of the users' ears and provide an optimal conformation.

### Second Embodiment

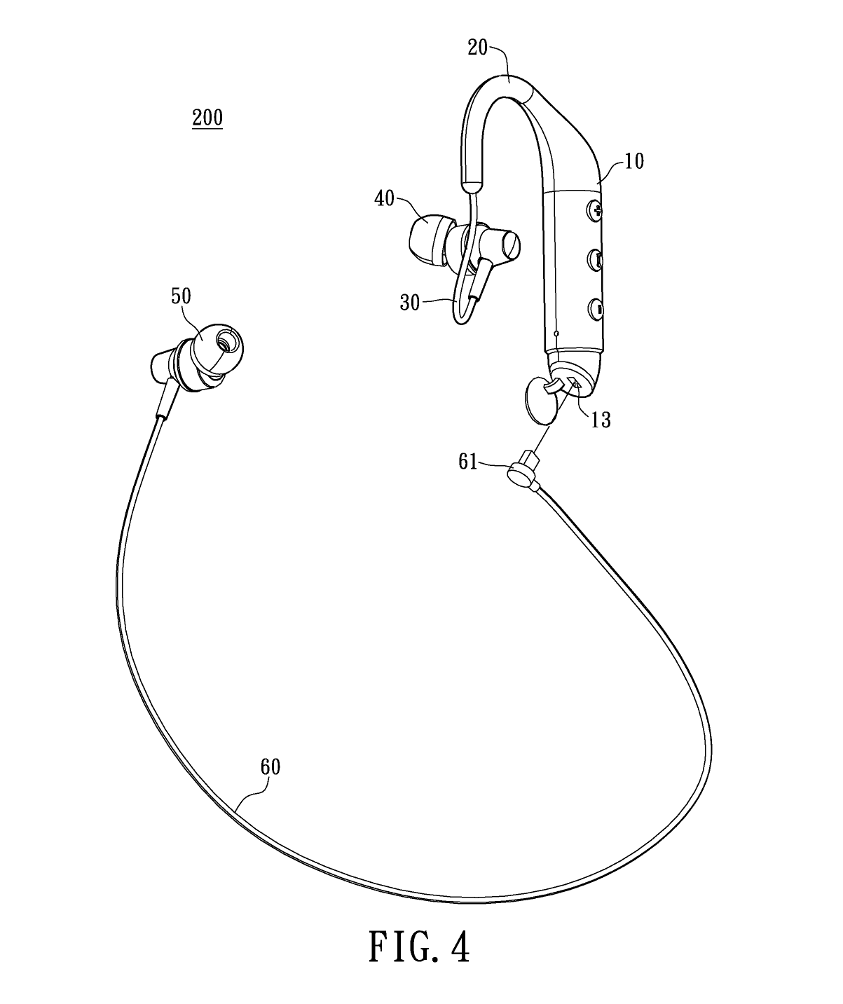

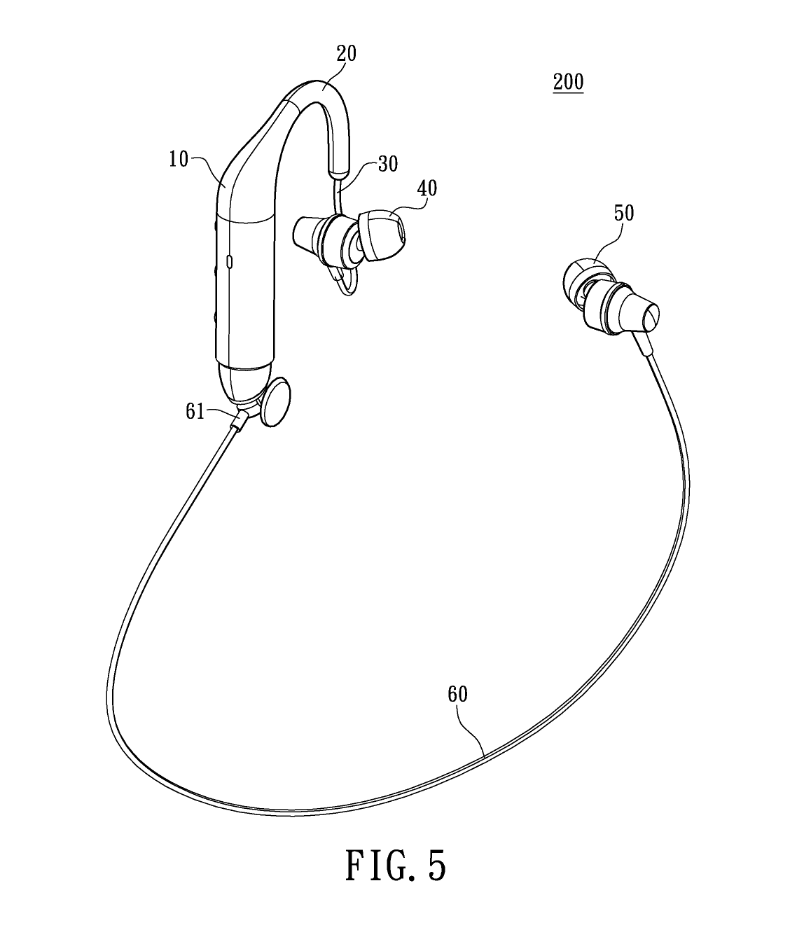

Please refer to FIG. 4 and FIG. 5. FIG. 4 is a partial exploded perspective schematic diagram of an instantly disclosed Bluetooth earphone 200. The Bluetooth earphone 200 differs from the above embodiment in that the main module 10 of the Bluetooth earphone 200 has a port 13 located on the end of the main module 10 further away from the ear hanger 20. Furthermore, the Bluetooth earphone 200 also includes an additional earpiece speaker (namely the second earpiece speaker 50) corresponding to the first earpiece speaker, and an additional flexible connection unit (namely the second flexible connection unit 60). The second flexible connection unit 60 has a length larger than that of the first flexible connection unit 30. The second earpiece speaker 50 is connected to the port 13 by the second flexible connection unit 60. The second flexible connection unit 60 has an electrical connector 61 corresponding to the port 13. The specification of the electrical connector 61 can be Mini USB or Micro USB but is not limited thereto.

During application, as shown in FIG. 5, the first earpiece speaker 40 can be inserted into one ear canal of the user, and the second earpiece speaker 50 can be inserted into the other ear canal of the user. Thereby, the Bluetooth earphone of the present invention can provide the user with the effect of listening to stereo. Moreover, the first earpiece speaker 40 is connected by suspension on the ear hanger 20 by the first flexible connection unit 30. Therefore the first earpiece speaker 40 does not have create resonance resulting in feedback with the main module 10, and can provide the user with the optimal effect of listening to stereo.

Potential Advantages of the Embodiments

In summary of the above, the instant disclosure provides a Bluetooth earphone which can improve the conformation and eliminate feedback between the earpiece speaker and the main module by connecting the earpiece speaker by suspension to the ear hanger via a flexible connection unit and further including an auxiliary earpiece speaker. Therefore, the earpiece speaker of the instantly disclosed Bluetooth earphone is not restricted by the angle of the user's ear canal, and does not create feedback due to resonance between an earpiece speaker and the main module which would result in a difference in listening between the two earpiece speakers.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A Bluetooth earphone, comprising:
a main module for transmitting and receiving Bluetooth signals having a generally elongated body;
an ear hanger curvingly extending from one end of the main module; and
a first earpiece speaker connected to the ear hanger by a first flexible connection unit.

2. The Bluetooth earphone according to claim 1, wherein the main module has a port located on the other end of the main module away from the ear hanger.

3. The Bluetooth earphone according to claim 2, further comprising a second earpiece speaker connectable to the port through a second flexible connection unit, wherein the length of the second flexible connection unit is larger than that of the first flexible connection unit.

4. The Bluetooth earphone according to claim 3, wherein the second flexible connection unit comprises an electrical connector corresponding to the port.

5. The Bluetooth earphone according to claim 4, wherein the electrical connector is a Mini USB connector or a Micro USB connector.

6. The Bluetooth earphone according to claim 5, wherein the first and second flexible connection units are audio cables.

7. The Bluetooth earphone according to claim 6, wherein the first earpiece speaker is suspendingly connected to a distal end of the ear hanger away from the generally elongated body by the audio cable.
